(19) United States
(12) Patent Application Publication
(10) Pub. No.: US 2006/0204246 A1
(43) Pub. Date: Sep. 14, 2006

(54) Method and apparatus for determining characteristic deterioration in device

(75) Inventors: Takuya Suemura, Kawasaki (JP); Yoshihiro Onoda, Kawasaki (JP); Kazuyuki Fujiwara, Kawasaki (JP); Hideaki Koyano, Kawasaki (JP)

Correspondence Address: BINGHAM MCCUTCHEN LLP, 3000 K STREET, NW, BOX IP, WASHINGTON, DC, 20007, US

(73) Assignee: FUJITSU LIMITED

(21) Appl. No.: 11/167,096

(22) Filed: Jun. 28, 2005

(30) Foreign Application Priority Data
Mar. 9, 2005 (JP) 2005-066002

(51) Int. Cl. H04B 10/00

(52) U.S. Cl. 398/135

(57) ABSTRACT

In a method and an apparatus for determining characteristic deterioration in an individual device, an initial status value of the device is stored, preferably per temperature, a present status value of the device in operation is stored preferably corresponding to the temperature, the initial status value and the present status value are read corresponding to the temperature to normalize the present status value with the initial status value, and it is determined whether or not the normalized value is within a normal range.

### BACKGROUND OF THE INVENTION

1. Field of the Invention

The present invention relates to a method and an apparatus for determining characteristic deterioration in a device, and in particular to a method and an apparatus for determining characteristic deterioration in a device such as an optical transceiver.

2. Description of the Related Art

FIG. 7 schematically shows a method for determining characteristic deterioration in/of a device known in the art. In this prior art, a present status value of e.g. an optical transceiver in operation is once stored in an RAM (Random Access Memory) (step S41), the present status value y is read from the RAM (step S42), and whether or not the present status value y is within a normal range (between lower limit value yₘᵢₙ and upper limit value yₘₐₓ) is determined (step S43).

Namely, if the present status value y resides between the lower limit value yₘᵢₙ and the upper limit value yₘₐₓ, no alarm notification is generated deeming it normal (step S44), while if it goes out of the normal range, an alarm notification is generated deeming it abnormal (step S45).

Meanwhile, there has been proposed a control rod driving apparatus comprising a control device in which when the value of current, voltage or power supplied to a motor measured by a measuring means attains a predetermined value less than a limit value causing a magnetic joint connecting the motor and a control rod to lose synchronization, the control device executes at least one of a disconnection of the power supply to the motor, an indication to the effect that the predetermined value has been attained, and an occurrence of alarms (see e.g. patent document 1). [Patent document 1] Japanese patent application laid-open No. 2001-99974

Accordingly, there has been such a problem that since devices such as optical transceivers are different in characteristics depending on their makers or individual bodies and values served for determining characteristic deteriorations in operation of the devices depend on makers or individual bodies, if the present status value y is determined with the lower limit value yₘᵢₙ and the upper limit value yₘₐₓ that are general standard values as in the prior art shown in FIG. 7, it becomes difficult to determine the characteristic deterioration depending on the individual bodies, causing an adverse determination accuracy.

### SUMMARY OF THE INVENTION

It is accordingly an object of the present invention to provide a method and an apparatus for accurately determining characteristic deterioration in a device depending on its individual body.

For solving the above object, a method for determining characteristic deterioration in device according to the present invention comprises a first step of storing an initial status value of a device; a second step of storing a present status value of the device in operation; a third step of reading the initial status value and the present status value to normalize the present status value with the initial status value, and of determining whether or not the normalized value is within a normal range.

The method of this invention will now be described with reference to a schematic flowchart shown in FIG. 1.

At first, an initial status value x of a device is written in, for example, a memory (step S1). Then, a present status value y of the device is written in, for example, a second memory (step S2). Then, the initial status value x and the present status value y written in the respective memories are read therefrom (step S3).

Then, a value a=y/x where the present status value y is normalized by the initial status value x read at step S3 is determined (step S4). It is then determined whether or not the normalized value thus determined comes into a normal range (between determination values a₁ and a₂) obtained experimentally or the like (step S5).

If it is found from the result that a₁<a<a₂, no alarm notification is generated supposing that the normalized value “a” resides in the normal range (step S6) while otherwise an alarm notification is generated supposing that the normalized value “a” falls outside the normal range (step S7).

Thus, the determination of characteristic deterioration is performed by a normalized value based on the initial status value x depending on individual devices, so that it becomes possible to make a determination depending on individual devices, enhancing the determination accuracy.

The above first step may comprise storing the initial status value which is a value within a predetermined range (xₘᵢₙ<x<xₘₐₓ) at a time of factory shipment of the device per external environment condition such as temperature, and the above third step may comprise reading the present status value corresponding to the external environment condition.

This enables various initial status values corresponding to various temperatures of a device to be stored in advance and the present status value corresponding to actual temperatures to be read, thereby enhancing the determination accuracy.

The first step may comprise adding storage confirming data or normality confirming data to the initial status value to be stored, and the third step may comprise reading only the initial status value which has been confirmed for the data.

An apparatus for determining characteristic deterioration in device may comprise: first means storing an initial status value of a device; second means storing a present status value of the device during operation; third means reading the initial status value and the present status value to normalize the present status value with the initial status value, and determining whether or not the normalized value is within a normal range.

The first means may store the initial status value per external environment condition, and the third means may read the present status value corresponding to the external environment condition.

The first means may add storage confirming or normality confirming data to the initial status value to be stored, and the third means may read only the initial status value which has been confirmed for the data.

The effect of the present invention will be described with reference to FIG. 2 in the following:

As shown in FIG. 2, by applying linear coefficients a₁, a₂ (a₁<a<a₂) at step S5 to a linear curve P:y=ax obtained at step S4, a linear curve O:y=a₁x and a linear curve Q:y=a₂x are obtained.

If the initial status value x of a certain device is in a predetermined range (xₘᵢₙ<x<xₘₐₓ), the present status value y will assume the following range:
yₘᵢₙ(a₁xₘᵢₙ)<Y<yₘₐₓ(a₂xₘₐₓ) Eq.(1)

Therefore, the maximum range determined by both of the initial status value and the present status value is as shown by a hatched portion.

Since the prior art shown in FIG. 7 confirms normality only with the present status value y without using the initial status value, it means that the normal range of the present status value y is prescribed between the lower limit value yₘᵢₙ and the upper limit value yₘₐₓ regardless of the initial status value x.

To the contrary, the present invention varies the initial status value x within a range of xₘᵢₙ<x<xₘₐₓ, so that the present status value y will assume the following range supposing that the initial status value x assumes a value shown in figure:
y₁<y<y₂ Eq.(2)

Accordingly, since a range for determining the normality becomes narrower in Eq.(1) than Eq.(2), alarm determination accuracy is improved, enabling the determination according to analog characteristics of individual devices to be made possible.

### BRIEF DESCRIPTION OF THE DRAWINGS

The above and other objects to be made possible and advantages of the invention will be apparent upon consideration of the following detailed description, taken in conjunction with the accompanying drawings, in which the reference numerals refer to like parts throughout and in which:

FIG. 1 is a flowchart showing an operation concept of a method and an apparatus for determining characteristic deterioration in device according to the present invention;

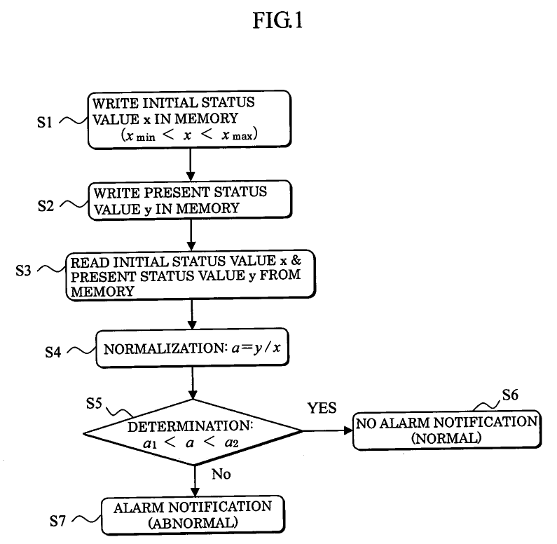

FIG. 2 is a graph for describing a difference of normal ranges upon alarm determination between the present invention and the prior art;

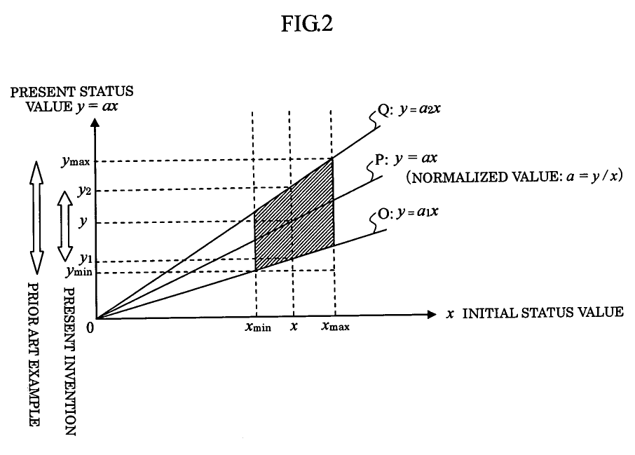

FIG. 3 is a block diagram showing an arrangement embodiment of an apparatus for determining characteristic deterioration in device according to the present invention;

FIG. 4 is a flowchart showing an operation embodiment (1) of a method and an apparatus for determining characteristic deterioration in device according to the present invention;

FIG. 5 is a flowchart showing an operation embodiment (2), where an external environment condition comprises a temperature, of a method and an apparatus for determining characteristic deterioration in device according to the present invention;

FIG. 6 is a flowchart showing an embodiment for performing normality confirmation upon writing an initial status value in EEPROM in the respective embodiments in a method and an apparatus for determining characteristic deterioration in device according to the present invention; and

FIG. 7 is a flowchart showing a prior art example.

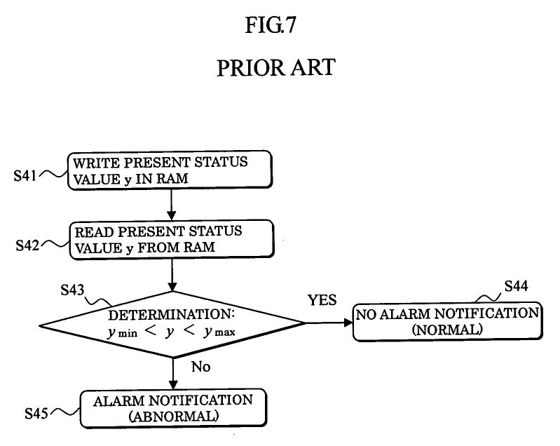

### DESCRIPTION OF THE EMBODIMENTS

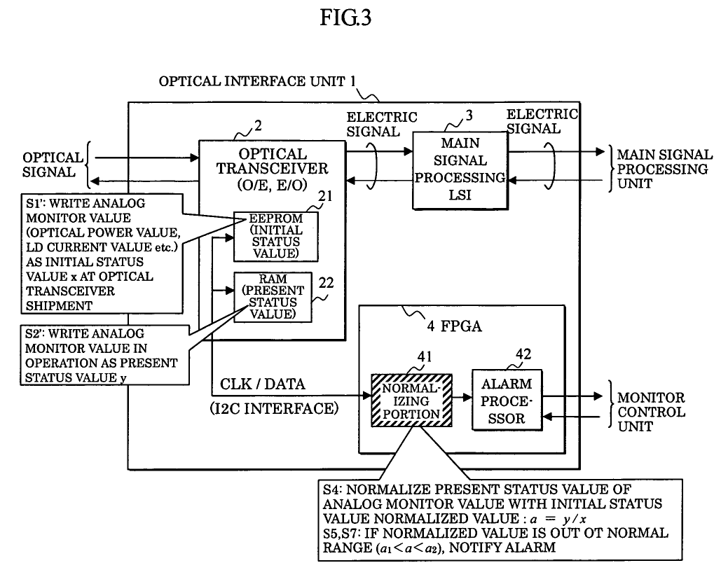

FIG. 3 shows one embodiment of an apparatus realizing a method for determining characteristic deterioration in device according to the present invention. This embodiment is adapted to an optical interface unit 1 which is an object to be determined for its characteristic deterioration, and formed of an optical transceiver (O/E, E/O) 2 which converts an optical signal to an electric signal or an electric signal to an optical signal, a main signal processing LSI3 which converts an electric signal from the optical transceiver 2 to an electric signal for a main signal processing unit (not shown), and an FPGA (Field Programmable Gate Array) 4 which provides data to a monitor control unit (not shown) based on clocks CLK and data DATA from the optical transceiver 2.

The optical transceiver 2 is formed of an (EEPROM (Electrically Erasable Programmable Read-Only Memory) 21 and an RAM 22, and the FPGA 4 is formed of a normalizing portion 41 for normalizing data from the optical transceiver 2, and an alarm processor 42 which sends an output signal of the normalizing portion 41 to the monitor control unit.

### Operation Embodiment (1)

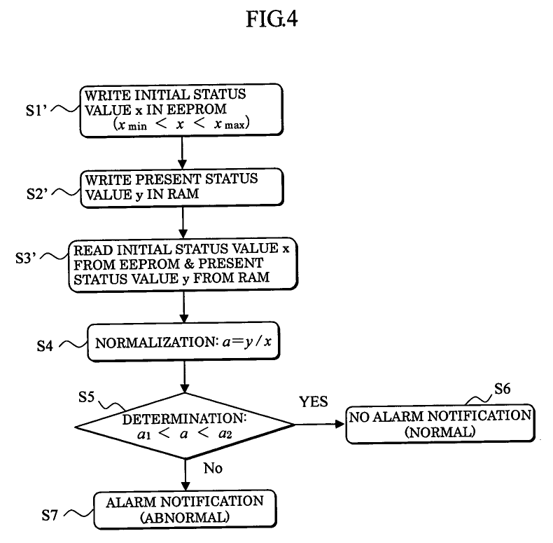

FIG. 4 shows an operation embodiment (1) of an arrangement shown in FIG. 3, which will be described referring to the flowchart of FIG. 4 as follows:

Firstly in the optical transceiver 2, an analog monitor value (optical power value, an LD current value etc.) at the time of factory shipment of the optical transceiver 2 is written as an initial status value x in the EEPROM 21 (step S1′). At this time, a certain standard or specifications (xₘᵢₙ<x<xₘₐₓ) is preset for the initial status value x whereby individual devices off the standard are preliminarily removed, determining that they are abnormal at the initial stage.

Next, an analog monitor value in operation of the optical transceiver 2 is written as the present status value y in the RAM 22 (step S2′).

Then, the optical transceiver 2 reads the initial status value x from the EEPROM 21 and reads the present status value y from the RAM 22 to be forwarded to the normalizing portion in the FPGA4, where data DATA from the optical transceiver 2 to the FPGA 4 are applied with I2C interface.

The normalizing portion 41 calculates a normalized value a=y/x obtained from the initial status value x and the present status value y of the analog monitor value read from the optical transceiver 2 (step S4), determines whether or not the normalized value “a” is within a normal standard range (a₁<a<a₂) (step S5) and makes a notification as an alarm from the alarm processor 42 to the monitor control unit if it is found to be off the range (step S7).

### Operation Embodiment (2)

The analog monitor value (optical power) LD current etc. depends on an external environment condition, specifically a temperature. Therefore, it is preferred to determine a normality of the analog monitor value in view of a variation of the external environment condition.

Accordingly, by exemplifying temperature as the external environment condition, an embodiment for determining characteristic deterioration in device according to the present invention will be described in view of temperature variation as follows:

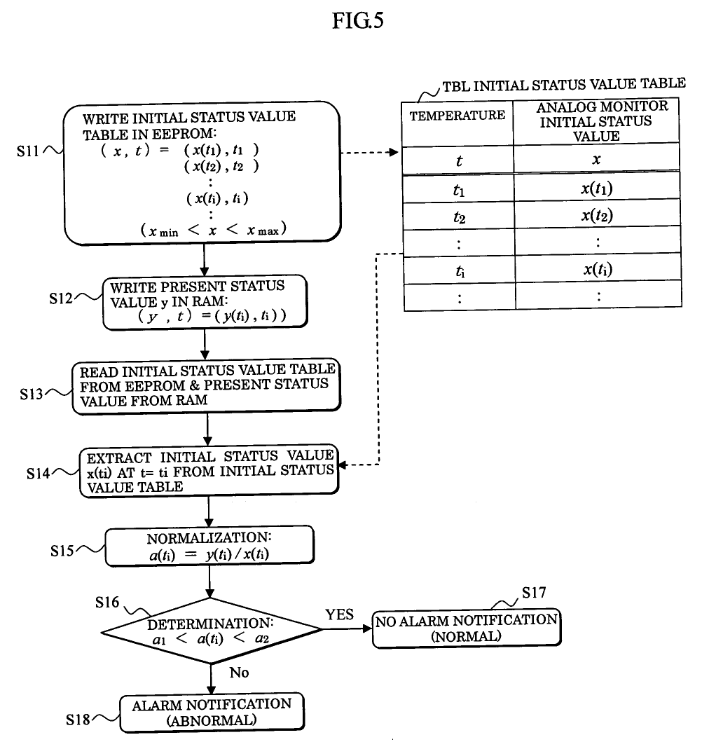

FIG. 5 shows a flowchart of this embodiment (2) where temperature is adopted as the external environment condition. A thermal measuring device such as a thermocouple is equipped in the optical transceiver 2 to monitor the temperature data. Then at the time of factory shipment of the optical transceiver 2, an initial status value data table TBL for temperature and analog monitor value (initial status value x) is prepared and written in the EEPROM 21 as shown on the right side of step S11 while the temperature condition is being changed (step S11). Namely, supporting that temperature is represented by t and the analog monitor value is represented by x, temperatures t and analog monitor values x are written in the initial status value data table TBL as the temperature t is changed, as shown at step S11 where xₘᵢₙ<x<xₘₐₓ.

In operation of the optical interface unit 1, both of the present status value y of the analog monitor value and present temperature data from the temperature measuring device in the optical transceiver 2 are written in the RAM 22 as a combination. Supposing that temperature t=tᵢ at the time of the present status value y, data written in the RAM 22 are expressed as shown at step S12.

Then, with the I2C interface, the data of the initial status value table TBL are read from the EEPROM 21, the present temperature and the present status value y associated with the present temperature are read from the RAM 22 to be provided to the normalizing portion 41 in the FPGA4 (step S13).

Then, the normalizing portion 41 reads data of the present status value y and the temperature data, extracts from the initial status value data table TBL an initial status value x(tᵢ) coincident with the temperature data (step S14) and calculates a normalized value a(tᵢ) according to the temperature condition in operation.

Namely, the initial status value x(tᵢ) at the time of temperature t(tᵢ) is extracted to calculate the normalized value a(tᵢ) as shown at step S15.

Supposing that the normal range for the normalized value is a₁<a<a₂, the normalizing portion 41 makes an alarm notification to the monitor control unit through the alarm processor 42 when the normalized value a(tᵢ) is outside the normal range (step S18).

It is to be noted that standard values a₁, a₂ for the initial status value are independent of the temperature t.

### Embodiment of Normality Confirmation in Initial Status Value Writing

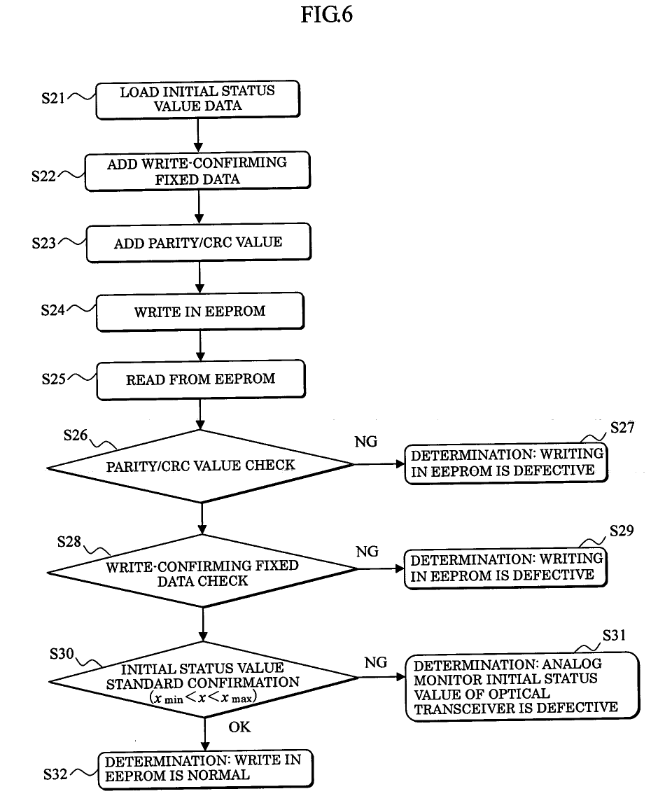

FIG. 6 shows a flowchart for confirming normality when the initial status value x is written in EEPROM 21. As above described, the initial status value x of the analog monitor value unique to each individual device is loaded at the time of factory shipment of the optical transceiver 2 (step S21). At this time, for prevention of the initial status value from being failed to be written, fixed data are added to the initial status value (step S22). Furthermore, for the confirmation of the normality of the initial status value, parity or CRC value may be added to the value (step S23).

Thus, the initial status value x added with writing-confirmation data or normality confirmation data is written in the EEPROM 21 (step S24).

Then, when it is read from the EEPROM 21, in response to step S23, whether or not check result of parity/CRC value is normal is checked (step S26). If the determination result found to be “NG”, it is determined that the writing in the EEPROM 21 failed (step S29).

If it is found at step S28 that the fixed data are normal, confirmation of the initial status value x is checked for the standard (step S30). This is done to determine whether or not the initial status value x is in a range between the lower limit value xₘᵢₙ and the upper limit value xₘₐₓ, as above described. If the determination result found to be “NG”, it is determined that the analog monitor initial status value of the optical transceiver 2 is bad (step S31). While only if the check result is found normal, the process proceeds to step S1′ shown in FIG. 4 or step S11 and the following shown in FIG. 5, supposing that the writing in the EEPROM 21 has been normally done (step S32).

What is claimed is:

1. A method for determining characteristic deterioration in a device comprising:
a first step of storing an initial status value of the device;
a second step of storing a present status value of the device in operation;
a third step of reading the initial status value and the present status value to normalize the present status value with the initial status value, and of determining whether or not the normalized value is within a normal range.

2. The method for determining characteristic deterioration in device as claimed in claim 1, wherein the first step comprises storing the initial status value per external environment condition, and the third step comprises reading the present status value corresponding to the external environment condition.

3. The method for determining characteristic deterioration in device as claimed in claim 1, wherein the first step comprises adding storage confirming data or normality confirming data to the initial status value to be stored, and the third step comprises reading only the initial status value which has been confirmed for the data.

4. The method for determining characteristic deterioration in device as claimed in claim 1, wherein the initial status value comprises a value within a predetermined range at a time of factory shipment of the device.

5. The method for determining characteristic deterioration in device as claimed in claim 1, wherein the external environment condition comprises a temperature.

6. An apparatus for determining characteristic deterioration in a device comprising:
first means storing an initial status value of the device;
second means storing a present status value of the device during operation;
third means reading the initial status value and the present status value to normalize the present status value with the initial status value, and determining whether or not the normalized value is within a normal range.

7. The apparatus for determining characteristic deterioration in device as claimed in claim 6 wherein the first means store the initial status value per external environment condition, and the third means read the present status value corresponding to the external environment condition.

8. The apparatus for determining characteristic deterioration in device as claimed in claim 6, wherein the first means add storage confirming or normality confirming data to the initial status value to be stored, and the third means read only the initial status value which has been confirmed for the data.

9. The apparatus for determining characteristic deterioration in device as claimed in claim 6, wherein the initial status value comprises a value within a predetermined range at a time of a factory shipment of the device.

10. The apparatus for determining characteristic deterioration in device as claimed in claim 6, wherein the external environment condition comprises a temperature.
